(19) United States
(12) Patent Application Publication
(10) Pub. No.: US 2014/0038762 A1
(43) Pub. Date: Feb. 6, 2014

(54) TRANSMISSION FOR A VEHICLE

(71) Applicant: ZF Friedrichshafen AG, Friedrichshafen (DE)

(72) Inventor: Michael WECHS, Lindau (DE)

(73) Assignee: ZF Friedrichshafen AG, Friedrichshafen (DE)

(21) Appl. No.: 13/946,019

(22) Filed: Jul. 19, 2013

(30) Foreign Application Priority Data
Aug. 2, 2012 (DE) 10 2012 213 711.4

(51) Int. Cl. F16H 37/04

(52) U.S. Cl. CPC F16H 37/046
USPC 475/218

(57) ABSTRACT

A double clutch transmission for a vehicle comprising partial transmissions with an input shaft positioned on an input axis and an output shaft is positioned on the input axis or is at least positioned parallel to a counter shaft axis. A planetary transmission is connected with the output shaft and at least one of the input shafts can be connected with the output shaft via the planetary transmission. M wheel planes and N shifters are positioned, M and N are each natural numbers which are both greater than or equal to 2, and whereby at least N−1 shifter are positioned on the input shaft axis. At least a shift element of one of the N−1 shifter is connected with a shift element of additional N−1 shifters, and in each case a transmission element of two wheel planes is or can be connected with the shaft.

This application claims priority from German patent application serial no. 10 2012 213 711.4 filed Aug. 2, 2012.

### FIELD OF THE INVENTION

The invention relates to a transmission, in particular a double clutch transmission, for a vehicle, comprising at least two partial transmissions, wherein each partial transmission has at least an input shaft on the drive side of the transmission, which is positioned on an input shaft axis, and has an output shaft as a driven shaft which has at least two partial transmissions on an output side of the transmission, wherein the output shaft is positioned on the input shaft axis, or on a counter shaft axis parallel to the input shaft axis, a reduction gear, wherein the reduction gear comprises at least one counter shaft and wherein the at least one counter shaft is positioned on a counter shaft axis, as well as a planetary transmission which can be coupled with the output shaft, wherein at least one of the input shafts can be connected, via at least one gear plane and/or at least a shift element and via the planetary transmission, with the output shaft.

### BACKGROUND OF THE INVENTION

Transmissions for motor vehicles are, among other things, designed as so-called double clutch transmissions in which each input shaft is assigned to a partial transmission and in which the input shafts of both partial transmissions are each connected, via an associated load shift element, to a drive, for instance a combustion engine or an electric motor wherein the two load shift elements hereby, in the form of a double clutch, are grouped together. The gear steps available by way of such a transmission can then be split between both partial transmissions such that, for instance, the odd gears are available via one of the partial transmissions and the even gears are accordingly available via the other partial transmission. It is also known to arrange the individual gear steps in one or several gear planes or levels. By means of the respective shift elements, is it possible to engage them in into the flow of force and torque between input and output, such that respective, desired ratios between the input and output of the transmission are in each case available.

Through an alternating layout of gears in both partial transmissions, it is possible to preselect, while driving in a gear in one of the partial transmissions, the next following gear by respective activation of the shift elements, wherein the final change into the following gear is achieved through the disengagement of the shift element of the one transmission and then immediately following this the engagement of the shift element of the other partial transmission. Through this procedure, gears or gear steps of the transmission can be shifted under load which improves the ability of the motor vehicle accelerate by changing gears with essentially no interruption of traction force.

Such double clutch transmissions are also designed with primary reduction gearing which is assigned to the drive and output, so that a compact construction in the axial direction is made possible.

Known from DE 10 2006 054 281 A1 is a transmission for a motor vehicle in form of a double clutch transmission. The double clutch transmission comprises two partial transmissions, each having an input shaft. Through the connection of the input shaft via a respective load shift element, each of the partial transmissions can alternatively be engaged into a flow of force or torque, passing from a drive to the output, wherein the input shaft of the first partial transmission is designed as the center shaft of the transmission and the input shaft of the second partial transmission is designed as a transmission hollow shaft. Also, an output shaft, which is designed as the output of both partial transmissions, is arranged, wherein rotation of the drive can be transferred, via several ratio steps, to the output when flow of force and torque is guided by primary reduction gearing. Herein, at least two gear planes are shifted by actuating respective shift elements into the flow of force and torque, wherein through a combination of shift element actuation and the flow of force and torque via respective gear planes, several gear ratio steps can be achieved. It is also possible to directly transmit rotation of the drive to an output shaft of the output through the activation of the respective shift elements.

Known from DE 10 2007 049 267 A1 is an additional transmission for a motor vehicle in the form of a double clutch transmission. The double clutch transmission comprises two input shafts and two counter shafts that are parallel to the input shafts, wherein the input shafts can be coupled via gear planes with the counter shafts. Also, positioned on one of the two counter shaft axes is a shift element which can couple two counter shafts, each of which has a gear wheel that are arranged in different gear planes. These gear wheels, which engage, are positioned in the gear planes on different input shafts. By means of these shift elements, the input shafts can therefore be indirectly connected or rather coupled to each other.

### SUMMARY OF THE INVENTION

It is therefore an object of the present invention to provide a transmission for a motor vehicle which has good load shift ability and a good ability for hybrid use. Furthermore, it is the object of the present invention to provide a transmission for a motor vehicle which can be manufactured simpler and less expensive, and at the same time reliably transfer torques between the drive and the output. An additional object of the present invention is to present an alternative transmission for a motor vehicle. Finally, it is the object of the present invention to allow an improved power increase.

These objectives are achieved with the transmission of the present invention, in particular a double clutch transmission, for a motor vehicle that comprises at least two partial transmissions, wherein each partial transmission has at least one input shaft on the input side of the transmission and which is positioned on an input shaft axis, an output shaft as the driven shaft of these at least two partial transmissions on the output side of the transmission, wherein the output shaft is positioned on the input shaft axis or at least, in particular parallel to the input shaft axis on a counter shaft, a primary reduction gear wherein the primary reduction gear has at least a counter shaft and wherein at least this one counter shaft is positioned on at least a counter shaft axis, as well as a planetary transmission which can be connected with the output shaft, wherein at least one of the input shafts can be connected via at least one gear plane and/or at least a shift element, as well as via the planetary transmission with the output shaft, because of the fact that M gear planes and N shift devices are positioned wherein M and N are natural numbers and larger than or equal to 2, that at least a shift element of one of the N−1 shift devices is connected via a shaft with at least a shift element of one of the additional N−1 shift devices and that each one transmission element of at least two gear planes can be connected or disconnected with the shaft.

The objectives of the invention is solved in a motor vehicle, in particular a passenger car or a car with a transmission in accordance with the invention.

One of the hereby achieved advantages is the fact that a comfortable possibility of the force division can be achieved, through the application of at least one counter shaft. Other advantages are that the transmission has a very good load shift ability and a good hybrid ability.

The term “Wheel Step” or “Gear plane” are preferably in the description, in particular in the claims, to be understood as being two transmission elements interacting with each other to transfer torques from a first transmission element to the other transmission element, which preferably provide an up or down transmission ratio for the interacting shafts in the transmission with the transmission elements.

The term “shift element” in the description and in particular in the claims, is preferably to be understood as a device which has at least a disengaged or engaged condition, wherein the device cannot transfer torque in the disengaged position, but can transfer torque in the engaged position between two devices which interact with these devices or rather the shift element.

The term “shift device” in the description and in particular in the claims, is preferably to be understood as at least one shift element and at least one shift element actuating device for actuating at least one shift element.

The term “transmission element” in the description and in particular in the claims, is preferably to be understood as a device through which force and/or torques can be transferred. Transmission elements can hereby preferably be designed as wheels, preferably gear wheels, spur wheels, bevel wheels, worm wheels, or the like.

Transmission elements are, in particular in the description and in the claims, preferably designed as fixed wheels or idler wheels. If the transmission elements are designed as idler wheels, they are then positioned on a hollow shaft and can be coupled by means of a shift element to an additional shaft on the same axis of the transmission.

Other advantageous embodiments, characteristics, and advantages of the invention are described in the dependent claims.

It is expedient that all shift devices of the transmission are positioned on the input shaft axis. One of the advantages achieved hereby is that the primary reduction gearing does not have shift elements or rather shift devices so that simple and reliable power division can be realized through the primary reduction gearing. Furthermore, it allows larger torques to be transmitted from the drive side to the output side. Another advantage is that the transmission can be designed to be compact in the radial direction, because there are no shift elements positioned on the counter shaft axis.

Preferably, at least two shafts of the transmission are positioned coaxial to each other. It reduces the construction space for at least the two shafts and also the transmission in total, so that the transmission also in tight conditions in a motor vehicle can be applied. If, for instance, two counter shafts are positioned coaxially, several counter shafts can therefore be provided which allows a configuration of a multitude of gears or gear steps, respectively, through the transmission.

It is expedient that the number N equals 6 and/or the number M is equal to 6. If there are now N=6 and/or M=6 shift devices or gear planes, respectively, positioned, several forward gear steps and reverse gear steps can at least be presented by the transmission, wherein the transmission can be constructed at the same time compact, so that it can be utilized in a multitude of motor vehicles.

Preferably, at least one of the shafts of the transmission is designed as a solid shaft and an additional shaft on the same axis of the transmission as a hollow shaft. This creates an especially space-saving configuration of both shafts, because the shaft which is designed as a hollow shaft can be positioned coaxially with and parallel to the shaft which is designed as a solid shaft. In this design as a solid shaft or as a hollow shaft, the respective transmission elements, if they need to be connected firmly with the solid shaft or the hollow shaft, can be manufactured with the respective shaft as one part and therefore cost-efficient. A time-consuming and therefore cost intensive mounting of respective transmission elements on the respective shafts can therefore be omitted.

It is expedient that at least one of the input shafts of the transmission can be connected with a shaft of the planetary transmission which is designed as a sun gear shaft. This design makes a more direct connection with the planetary transmission possible, when compared to a connection via an intermediate shaft of the transmission, such that the force and torque can be transferred directly to the planetary transmission.

Preferably, at least one gear plane is designed as reverse gear step. Through the at least one reverse gear step, the rotational direction of the output shaft can be reversed with respect to one of the input shafts, so that a reverse gear can be provided for a motor vehicle thereby significantly increasing the flexibility with regard to the application of the transmission in different motor vehicles.

It is expedient that the reverse gear step can be actuated at least through one of the N shift devices, wherein through at least one of the shift devices one of the input shafts can be connected with the reverse gear step. The advantage hereby is that this causes a possible direct transmission of force and torque from one of the input shafts, by means of the reverse gear step, to the primary reduction gearing.

As an advantage, this shift device, for the activation of the reverse gear step, is positioned furthest toward downstream, in the area of one of the input shafts on the input shaft axis. Therefore, a shortest travel for the force and torque flow is possible when activating the reverse gear step through the primary reduction gearing so that, by means of the reverse gear drives step or several reverse gears, respectively, an especially reliable transfer of force and torque from one of the input shafts to the output shaft is provided.

It is expedient that, by means of a shift element of the shift device for the actuation of the reverse gear step, at least one of the input shafts can be connected with a shaft of the planetary gear which is designed as sun shaft. One of the achieved advantages is that hereby the shift device for the actuation of the reverse gear step can be designed simpler because, dual to the one shift element, just two shafts on the same axis, meaning the input shaft axis, need to be connected.

Preferably, at least three reverse gears can be presented through the transmission. Hereby, a sufficient number of reverse gears are provided for a multitude of motor vehicles which enhances the flexibility in regard to the application of the transmission in different motor vehicles.

It is expedient that an electric machine be positioned at least one transmission element of a gear plane and/or at least one counter shaft and/or at least one of the shafts on the input shaft axis for the hybridization of the transmission, in particular by means of an additional shift device and/or a transmission element which is connected with it.

One of the achieved advantages is that the transmission can also be applied in hybrid vehicles in which an electric machine and also a combustion engine need to work together with the transmission to transfer force and the torque to the drive of the hybrid vehicle. The installation of at least one electric machine can hereby be performed at least at one of the input shafts, at the sun shaft, or at the output shaft, or at least at one of the counter shafts. The electric machine can also be linked to a transmission element of a gear plane in the sense of an idle gear. The respective transmission element can therefore be coupled by means of a shift element to the respective shaft.

It is also possible to link the electric machine to a transmission element in the sense of a fixed gearwheel, meaning to a transmission element which is in particular fixed and without any additional shift element directly connected with one of the shafts of the transmission. It is hereby especially advantageous to execute the link of the electric machine to the transmission by means of at least a shift element, in particular to a transmission element of a gear plane. The achieved advantage is that a so-called charging ability during idling is possible and an electric drive without drag losses. Hereby, the teaching content of the DE 10 2010 030 569 A1 is referenced explicitly: In it, a first input shaft can be coupled with a load shift element. A second input shaft, which is positioned in particular coaxial to the first input shaft, is directly connected with a rotor of the electric machine for its drive. Hereby, two parallel force transmission branches on the input side can be coupled with each other.

It is expedient to position the electric machine at a transmission element of at least one gear plane which is connected with a counter shaft, designed as a solid shaft. Hereby, an especially simple configuration or coupling, respectively, of the electric machine to the transmission, and thus a reliable force and torque transmission from the electric machine to the transmission, in particular ultimately to the output shaft.

A shift device for the actuation of the planetary transmission is advantageously positioned, which comprises at least a shift element wherein, by means of at least this one shift element, a ring gear of the planetary transmission can be connected in a rotationally fixed manner in an enclosure of the transmission. One of the hereby achieved advantages is that the ring gear of the planetary transmission can be used either as rotationally fixed or as freewheeling, which increases further the number of possible gear steps or transmission ratios, respectively. Besides this, a gear ratio into fast gear is made possible.

It is expedient that the shift device for the actuation of the planetary transmission comprise two shift elements wherein, by means of one of the shift elements, the ring gear can be coupled with a planetary carrier of the planetary transmission. The advantage hereby is that a direct drive of the planetary gear is made possible.

It is expedient that a planetary carrier shaft of the planetary transmission be designed as an output shaft. The advantage hereby is that an especially simple configuration and a simple output is made possible by means of the planetary gear set in the transmission. Additional parts or components to connect planetary(wheel) carrier or bar of the planetary transmission, respectively, planetary carrier shaft, an output shaft, are therefore not necessary.

It is advantageous to design a shift element of one of the N shift devices in a way that a transmission element on the input shaft axis, one of the M gear planes, can be connected with the planetary carrier of the planetary transmission. Hereby, a transmission of force and torques does not only happen by means of the sun shaft, but also by means of the planetary wheel area shaft, which increases further the flexibility of the transmission, in regard to several gear steps but also in regard to the application in different vehicles. Also, an especially reliable and direct transfer of force and torques is made possible from one of the gear planes to the output shaft.

It is expedient to position the N shift devices and the M gear planes and the planetary transmission in a way so that at least nine forward gears and at least three reverse gears can be provided by the transmission. Hereby, the transmission can enable a large number of forward gear steps and reverse gear steps for a multitude of vehicles, in particular for passenger cars as well and as for trucks.

The reverse gear step is advantageously positioned in a gear plane which is connected or can be connected with the sun shaft. Hereby it is possible, to couple the reverse gear step via the gear plane which is connected or can be connected with the sun shaft, even more directly with the sun shaft which further increases the reliability of the reverse gear step.

It is expedient that the primary reduction gearing comprises just a counter shaft which is designed as solid shaft. The advantage hereby is that the primary reduction gearing can be manufactured in a simple way and also at lower cost. Thus, one can omit complicated configurations of several counter shafts or the configuration of shift elements and/or shift devices on the counter shaft.

Additionally, important characteristics and advantages of the invention can be found in the description based on the drawings.

It is to be understood that the above-mentioned features and the features to be explained below can be used not only in the described combinations, but also in other combinations or alone without departing from the scope of the present invention.

### BRIEF DESCRIPTION OF THE DRAWINGS

Preferred designs and embodiments of the invention are presented in the drawings and will be explained further in the following description, wherein same reference characters referred to the same or similar or functional same components or elements.

It shows hereby in schematic form:

FIG. 1 a transmission in accordance with a first embodiment of the present invention;

FIG. 2 a shift matrix for a transmission in accordance with the first embodiment of the present invention;

FIG. 3 a transmission in accordance with a second embodiment of the present invention;

FIG. 4 a transmission in accordance with a third embodiment of the present invention;

FIG. 5 a transmission in accordance with a fourth embodiment of the present invention.

### DETAILED DESCRIPTION OF THE PREFERRED EMBODIMENTS

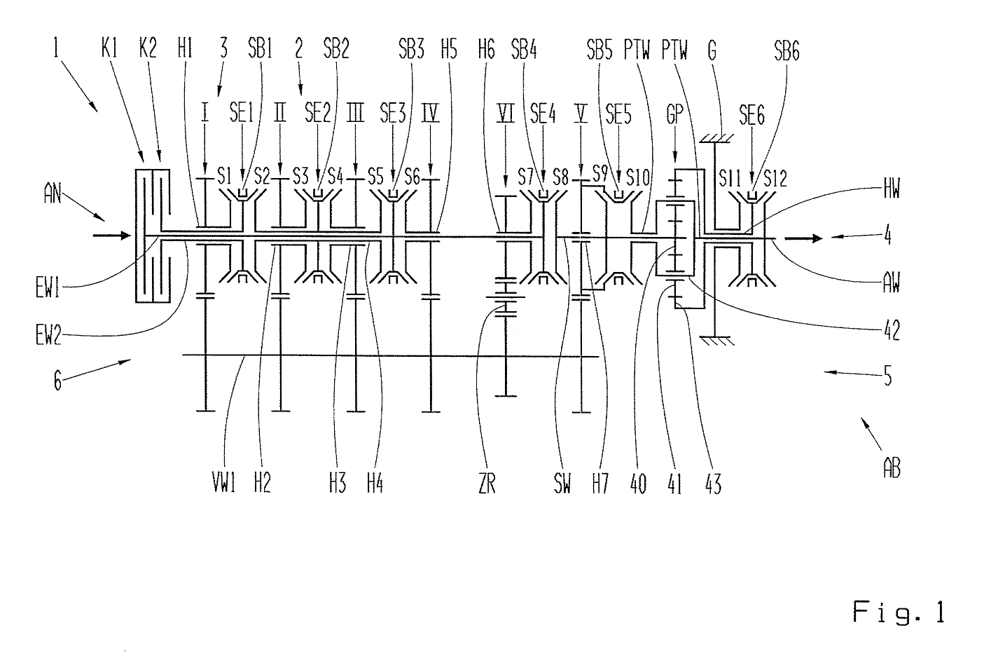

FIG. 1 shows a transmission in accordance with a first embodiment of the present invention.

In FIG. 1, the reference character 1 marks a transmission in the form of a double clutch transmission. The double clutch transmission 1 has two load shift elements in the form of clutches K1, K2. By means of the double clutch K1, K2, the drive side AN can hereby be coupled or rather connected with the output side AB of the transmission 1 for the transfer of force and torques. Hereby, the first clutch K1 is connected with a first input shaft EW1, and the second clutch is connected with a second input shaft EW2. The first input shaft EW1 is designed as a solid shaft, whereas the second input shaft EW2 is designed as a hollow shaft. The two input shafts are positioned hereby coaxially and parallel to each other, wherein the second input shaft EW2 is positioned on the radial outer side of the input shaft EW1.

In addition, the transmission 1 comprises two partial transmissions 2, 3. The first partial transmission 2 can be coupled or rather is connected with the first input shaft EW1. The second partial transmission can be coupled or rather is connected with the second input shaft EW2. A fourth gear plane IV and a seventh gear plane VII are assigned to the first partial transmission 2 and, the second partial transmission 2 has first, second, and third gear planes I, II, III assigned to it.

Further, the transmission 1 comprises an input shaft axis 4 on which the true input shafts EW1, EW2 are positioned. On the input shaft axis 4 is in addition, torque downstream of the two input shafts EW1, EW2, a sun shaft SW positioned which can be coupled at least with one of the input shafts EW1, EW2. The sun shaft SW is also connected to a planetary gear GP, specifically with a sun wheel 40 of the planetary transmission GP. The planetary transmission GP then connected with the output shaft AW.

Torque and force flow downstream from the drive side AN of the transmission 1, beginning from the two clutches K1, K2, the transmission 1 comprises initially a first gear plane I and then a first shift element S1, a second shift element S2, a second gear plane II, a third shift element S3, a fourth shift element S4, a third gear plane III, a fifth shift element S5, a sixth shift element S6, a fourth gear plane IV, a sixth gear plane VI in form of a reverse gear drive step, a seventh shift element S7, and eighth shift element S8, a fifth gear plane V, a ninth shift element S9, a tenth shift element S10, the planetary transmission GP, an eleventh shift element S11, as well as a twelfth shift element S12.

Each of the named gear planes I, II, III, IV, V, and VI has transmission elements, in particular in the form of gear wheels, which are each connected with a shaft of the transmission 1.

Parallel to the input shaft axis 4 is positioned a counter shaft axis 5 for a primary reduction gearing. And the primary reduction gearing 6 comprises a first counter shaft VW1 which is designed as a solid shaft. Between the input shaft axis 4 and the counter shaft axis 5 as the sixth gear plane VI an intermediate gear ZR the reverse the rotation direction, so that by means of the output shaft AW, and a same rotation direction of one of the input shafts EW1, EW2, a reversed rotation direction is made possible to provide at least one reverse gear.

Beginning from the drive side AN, the counter shaft axis 5 has, starting with the first gear plane I and then the second gear plane II, the third gear plane III, the fourth gear plane IV, the sixth gear plane VI, as well as the fifth gear plane V.

The planetary gear GP is basically constructed in the usual manner and comprises a central sun gear 40, which meshes at least with a planetary gear 41 at its radial outer side. The planetary gear or rather gears 41 are rotatably positioned on a planetary gear carrier 42, also called a bar. On the radial outer side of the planetary gears 41, a ring gear 43 of the planetary transmission GP is again positioned, which meshes with the planetary gears 41. The planetary carrier 42 is connected with a planetary (wheel) carrier shaft PTW, at the planetary gear GP which neighbors the drive side AN, as well and is the planetary gear GP which neighbors the output side AB. The planetary carrier shaft PTW, at the side of the transmission 1, which neighbors the output side AB, is designed as a solid shaft and output shaft AW. The planetary carrier shaft PTW is, at the side which neighbors the drive side AN, designed as a hollow shaft. The ring gear 43 is connected with a hollow wheel shaft HW which is designed as hollow shaft, which is positioned at the output side AB, neighboring the planetary gear GP.

In the following, the twelve shift elements, S1, S2, S3, S4, S5, S6, S7, S8, S9, S10, S11, and S12, are now described.

The below-mentioned respective switching element is connected to two shafts, one shaft and a transmission element, or two transmission elements of the transmission and establishes a connection for the transmission of force and torque between the respective shafts and/or transmitting elements for actuating forth.

The first shift element S1 is positioned on the input shaft axis 4 and is connected on one hand with the second input shaft EW2, and on the other hand with a first hollow shaft H1. The first hollow shaft H1 is positioned coaxially and parallel to the second input shaft EW2 on its radial outer side. A transmission element is positioned on the first hollow shaft H1, which interacts with a transmission element on the first counter shaft VW1 for the creation of the first gear plane I. The second shift element S2 is positioned on the input shaft axis 4 and is connected on one hand with the second input shaft EW2, on the other hand with the fourth hollow shaft H4. The fourth hollow shaft H4 is coaxial and parallel position to the first input shaft EW1 and its radial outer side.

The first shift element S1 and the second shift element S2 are together positioned in a first shift device SE1 and can be actuated by means of a common, first shift element actuation device SB1.

The third shift element S3 is positioned on the input shaft axis 4 and is connected on one hand with the fourth hollow shaft H4, and on the other hand with the second hollow shaft H2. The second hollow shaft H2 is positioned coaxially and parallel to the fourth hollow shaft H4, it its radial outer side. A transmission element is positioned on the second hollow shaft H2 which interacts with a transmission element on the first counter shaft VW1 for the creation of a second gear plane II. The fourth shift element S4 is positioned on the input shaft axis 4 and is connected on one hand with the fourth hollow shaft H4, on the other hand with the third hollow shaft H3. The third hollow shaft H3 is positioned coaxially and parallel to the fourth hollow shaft H4, at its radial outer side. A transmission element is positioned on the third hollow shaft H3, which interacts with a transmission element on the first counter shaft VW1 for the creation of a third gear plane III.

The third shift element S3 and the fourth shift element S4 are together positioned in a second shift device SE2 and can be actuated by a second shift element actuation device SB2.

The fifth shift element S5 is positioned on the input shaft axis 4 and on one hand is connected with the first input shaft EW1, and on the other hand with the fourth hollow shaft H4. The sixth shift element S6 is positioned on the input shaft axis 4 and is connected on one hand with the first input shaft EW1, and on the other hand with a fifth hollow shaft H5. The fifth hollow shaft H5 is positioned coaxially and parallel to the first input shaft EW1 on its radial outer side. A transmission element is on the fifth hollow shaft H5 positioned which interacts with a transmission element on the first counter shaft VW1 for the creation of the fourth gear plane IV.

The fifth shift element S5 and the sixth shift element S6 are together positioned in a third shift device SE3 and can be actuated by means of a third shift element actuation device SB3.

The seventh shift element S7 is positioned on an input shaft axis 4 and is connected on one hand with the first input shaft EW1, and on the other hand with a sixth hollow shaft H6. This sixth hollow shaft H6 is positioned coaxially and parallel to the first input shaft EW1, on its radial outer side. On the sixth hollow shaft H6 is a transmission element positioned which interacts with the intermediate gear ZR between the input shaft axis 4 and the counter shaft axis 5, and a transmission element on the first counter shaft VW1 for the creation of the sixth gear plane VI in the form of the reverse gear step. The eighth shift element S8 is positioned on the input shaft axis 4 and is connected on one hand with the first input shaft EW1, and on the other hand with the sun shaft SW.

This seventh shift element S7 and the eighth shift element S8 are together positioned in a fourth shift device SE4 and can be actuated by means of a fourth shift element actuation device SB4.

The ninth shift element S9 is positioned on the input shaft axis 4 and is connected on one hand with the sun shaft SW of the planetary gear GP, and on the other hand with the transmission element of a fifth gear plane V on the input shaft axis 4. The transmission element of the fifth gear plane V on the input shaft axis 4 is rotatably positioned on the seventh and hollow shaft H7 which is coaxial and parallel position to the sun shaft SW, at its radial outer side.

The ninth shift element S9 and the tenth shift element S10 are together positioned in a fifth shift device SE5 and can be actuated by means of a fifth shift element actuation device SB5.

The eleventh shift element S11 is positioned on the input shaft axis 4 and is connected on one hand with the ring gear shaft HW of the planetary gear GP, on the other hand with the enclosure G of the transmission. The twelfth shift element S12 is positioned on the input shaft axis 4 and is connected on one hand with the planetary carrier shaft PTW, designed as the output shaft AW, on the other hand with the ring gear shaft HW of the planetary carrier and GP. The ring gear shaft HW is hereby designed as hollow shaft and parallel and coaxial positioned to the planetary carrier shaft PTW, designed as output shaft AW, on its radial outer side. The eleventh shift element represents hereby a torque proof connection between the ring gear 43 in the planetary carrier/bar 42 of the planetary transmission GP.

The eleventh shift element S11 and the twelfth shift element S12 are together positioned in a sixth shift device SE6 and can be actuated by means of a sixth shift element actuation device SB6.

The shift element actuation device is SB1, SB2, SB3, SB4, SB5, and SB6 or the shift devices SE1, SE2, SE3, SE4, SE5, and SE6, respectively, can be in the case of two shift elements designed as double synchronization and in the case of one shift element as single synchronization.

In total, the transmission 1 has, in accordance with FIG. 1, two input shafts EW1, EW2 on the input shaft axis 4, wherein the first input shaft EW1 is designed as solid shaft and the second input shaft EW2 is positioned coaxially and parallel thereto and is designed as a hollow shaft. On the counter shaft axis 5, parallel to the input shaft axis 4, is a counter shaft VW1 positioned which is designed as solid shaft. In the direction of the output shaft AW, a sun shaft SW is positioned beside the two input shafts EW1, EW2, which is connected with the sun gear 40 of the planetary transmission GP. The planetary transmission GP is also connected with the output shaft AW which is also positioned on the input shaft axis 4. The planetary carrier shaft PTW of the planetary transmission GP is hereby designed as the output shaft AW.

The transmission 1, in accordance with FIG. 1, comprises six gear planes, I, II, III, IV, V, and VI, wherein the sixth gear plane is designed as reverse gear step. All gear planes I-VI are in particular designed as spur gear steps with discrete gear ratios. At each gear plane I, II, III, IV, V, and VI, are positioned in each case two transmission elements in the form of gear wheels. The reverse gear step V1 comprises hereby, between the input shaft axis 4 and the counter shaft axis 5, of a reverse element in the form of an intermediate gear ZR. Thus, a total of 13 transmission elements, in particular in the form of gear wheels, are here positioned. Furthermore, the transmission comprises a planetary transmission GP, which can be on one hand connected with one of the input shafts EW1, EW2, on the other hand with the output shaft AW.

The transmission 1, in accordance with FIG. 1, comprises therefore of a planetary transmission GP which can, by means of a shift device which comprises two shift elements, present two different gear ratios i₁=1 and i₂≠1 and therefore functions as a range group. In addition, in the transmission 1, in accordance with FIG. 1, the first gear plane I, the fourth gear plane IV, as well as the sixth gear plane VI can each be coupled by means of at least one shift element with at least one of the input shafts EW1, EW2. The second gear plane II and the third gear planes III can each be coupled by means of at least one shift element to a hollow shaft H4, coaxial to at least one of the input shafts EW1, EW2, which again can be coupled via in each case through at least a shift element with both input shafts EW1, EW2. The first input shaft EW1 which is designed as solid shaft can be coupled by means of at least one shift element to the sun shaft of the planetary gear GP. The fifth gear plane V can be coupled by means of in each case at least one shift element to the sun shaft SW and also to the planet area shaft PTW. The ring gear shaft HW, thus the shaft which is connected with the ring gear 43 of the planetary carrier GP, can be coupled by means of at least one shift element to the enclosure G of the transmission 1 as well and is also with the planetary carrier shaft PTW. The planetary carrier shaft PTW is hereby designed as the output shaft AW.

In total, at least nine forward gear steps and at least three reverse gear steps can be established by means of the transmission 1 as in FIG. 1.

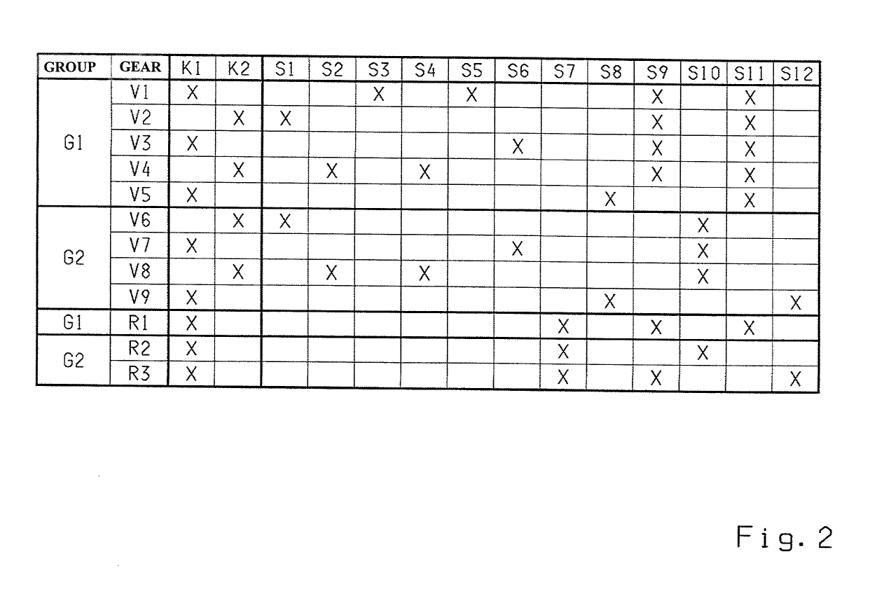

FIG. 2 shows a shift matrix for a transmission in accordance with the first embodiment of the present invention.

In FIG. 2 is a shift matrix presented for a transmission 1 in accordance with FIG. 1. Hereby, the horizontal plane shows the columns for the different groups G1, G2 (“Group”), for the presentation of the respective gear planes (“Steps”) which are embedded in the respective gears, the respective gear, wherein the forward gear steps are marked as V1 to V13, and the reverse gear steps with R1 to R8, and also the respective columns for the two clutches K1, K2, as well as the twelve shift elements S1 to S12. The entries which are left out in the shift matrix show that the respective shift element or rather the respective clutch is disengaged which means that the shift element or rather the clutch does not transfer any forces or torque to the respective shafts or transmission elements which are connected to the shift element or the clutch, respectively, which are connected to the shift element or the clutch. An entry marked with a cross in the shift matrix identifies a respective, actuated or rather engaged shift element or rather clutch which then transfers the forces and torques between the shafts or rather transmission elements which are connected to the shift element or rather clutch.

The steps in the shift matrix which are marked with letters relate hereby to the gear planes as follows: a relates to the first gear plane I, b relates to the second gear plane II, c relates to the third gear plane III, d relates to the fourth gear plane IV, e relates to the fifth gear plane V, and R relates to the sixth gear plane VI inform of the reverse gear step. The marking DD is to be understood as the abbreviation for “Direct Drive”, in which a direct drive through is enabled from the first input shaft EW1, without an embedding of gear planes, to the output shaft AW. The term “comprising”, in reference to gear planes and gears is to be understood especially in the sense of gear planes which are involved when a respective gear is enabled.

Furthermore, the reference character G1 marks the “slow” group of the fourth gears V1 to V5 or the reverse gear R1, respectively, the reference character G2 marks the “fast” group of the fourth gears V6 to V9 or the reverse gears R2 and R3, respectively.

Unless it is in the following not described differently, all clutches K1 and K2 and all shift elements and S1, S2, S3, S4, S5, S6, S7, S8, S9, S10, and S11, as well as S12 are each disengaged.

The first forward gear V1 comprises the gear planes II and V and for the presentation of the first forward gear V1, and the clutch K1, as well as the shift elements S3, S5, S9, and S11 are engaged. The second forward gear V2 comprises the gear planes I and V and for the presentation of the second fourth gear V2, the clutch K2 as well as the shift elements S1, S9, and S11 are engaged. The third forward gear V3 comprises the gear planes IV and V, and for the presentation of the third forward gear, the clutch K1, as well as the shift elements S6, S9, and S11 are engaged. The fourth forward gear V4 comprises the gear planes III and V and, for the presentation of the fourth forward gear V4, the clutch K2 as well as the shift elements S2, S4, S9, and S1, are engaged. The fifth forward gear V5 is designed as a direct gear (DD for Direct Drive) and, for the presentation of a fifth forward gear V5, the clutch K1, as well as the shift elements S8 and S11 are engaged.

The sixth forward gear V6 comprises the gear planes I and V and for the presentation of this sixth forward gear V6, the clutch K2 as well as the shift elements S1 and S10 are engaged. The seventh forward gear V7 comprises the gear planes IV and V and, for the presentation of the seventh forward gear V7 the clutch K1, as well as the shift elements S6 and S10, are engaged. The eighth forward gear V8 comprises the gear planes III and V and, for the presentation of the eighth forward gear V8, the clutch K2, as well as the shift elements S2, S4, and S10 are engaged. The ninth forward gear V9 is designed as a direct gear (DD for direct drive) and, for the presentation of the ninth forward gear V9 the clutch K1, as well as the shift elements S8 and S12, are engaged.

The first reverse gear R1 comprises the gear planes VI and V and, for the presentation of the first reverse gear R1, the clutch K1, as well as the shift elements S7, S9, and S11 are engaged. The second reverse gear R2 comprises the gear planes VI and V and, for the presentation of the second reverse gear R2, the clutch K1, as well and is the shift elements S7 and S10 are engaged. The third reverse gear R3 comprises the gear plane VI and V and, for the presentation of the third reverse gear R3, the clutch K1, as well as the shift elements S7, S9, and S12 are engaged.

In total, nine forward gears V1 to V9 and three reverse gears R1 to R3 can be presented by means of the shift matrix in FIG. 2 through the transmission 1. The forward gears V1 to V9, as well as the reverse gears R1 to R3, are hereby assign to different groups, G1 to G2, wherein the first group G1 comprises the forward gears V1 to V5 and the first reverse gear R1, and the second group G2 comprises the forward gears V6 to V9 can do to reverse gears R2 to R3. The first group G1 is the “slow” group, whereas the second group is the “fast” group the transmission.

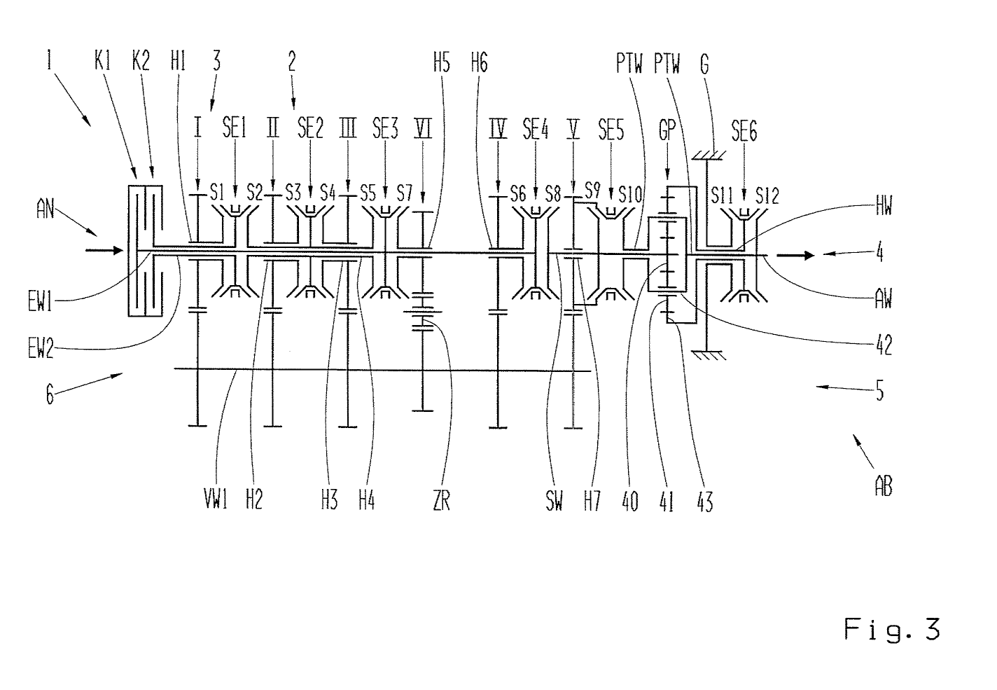

FIG. 3 shows a transmission in accordance with the second embodiment of the present invention.

A transmission 1, in accordance with FIG. 1, is mainly shown in FIG. 3. As a difference to the transmission 1 in accordance with FIG. 1, the transmission 1 in accordance with FIG. 3, the fourth gear plane IV and the sixth gear plane VI, as well as the shift elements S6 and S7 have been swapped and positioned in regard to their axial position on the input shaft axis 4 or counter shaft axis 5. The seventh shift element S7 is now connected with the first input shaft EW1 and with the fifth hollow shaft H5. On the fifth hollow shaft H5, the transmission element is positioned which works together with the intermediate gear ZR, between the input shaft axis 4 and the counter shaft axis 5, and the transmission element on the first counter shaft VW1 to create this sixth gear plane VI in the form of the reverse gear step. This seventh shift element S7 is now together positioned with the fifth shift element S5 in the third shift device SE3 and can be activated by means of the third shift element actuation device SB3.

The sixth shift element S6 is connected on one hand with the first input shaft EW1, on the other hand with the sixth hollow shaft H6. On the sixth hollow shaft H6 is the transmission element positioned which works together with the transmission element on the first counter shaft VW1 for the creation of the fourth gear plane IV. The sixth shift element S6 is now together positioned with the eighth shift element S8 in the fourth shift device SE4 and can be actuated by means of the fourth shift element actuation device SB4.

The sequence of gear planes and shift elements on the input shaft axis 4 is now, starting from the drive side AN, as follows: first gear plane I, first shift element S1, second shift element S2, second gear plane II, third shift element S3, fourth shift element S4, third gear plane III, fifth shift element S5, seventh shift element S76 gear plane VI, fourth gear plane IV, sixth shift element S6, eighth shift element S8, fifth gear plane V, ninth shift element S9, tenth shift element S10, eleventh shift element S11, as well as the twelfth shift element S12.

Alternatively or in addition, the second gear plane II and the third gear plane III, as well as the respective shift elements S3 and S4 can be swapped and positioned in regard to their axial position on the input shaft axis 4 of the counter shaft axis 5. In this case, a fourth shift element S4 is connected with the second hollow shaft H2 on one side, on the other side with the fourth hollow shaft H4. On the second hollow shaft H2 is then the transmission element positioned, which works together with the transmission element on the first counter shaft VW1 for the creation of the third gear plane III. The third shift element S3 is now on one hand connected with the fourth hollow shaft H4, on the other hand with the third hollow shaft H3. On the third hollow shaft H3 is then the transmission element positioned which works together with the transmission element on the first counter shaft VW1 for the creation of the second gear plane II.

The third shift element S3 and the fourth shift element S4 are still together positioned in the second shift device SE2 and can be actuated by means of the second shift element actuation device SB2.

In this alternative exclusively, the sequence of gear planes and shift elements, starting from the drive side AN would be as follows on the input shaft axis 4. First gear plane I, first shift element S1, second shift element S2, third gear plane III, fourth shift element S4, third shift element S3, second gear plane II, fifth shift element S5, sixth shift element S6, fourth gear plane IV, sixth gear plane VI, seventh shift element S7, eighth shift element S8, fifth gear plane V, ninth shift element S9, tenth shift element S10, planetary gear GP, eleventh shift element S11, as well as the twelfth shift element S12.

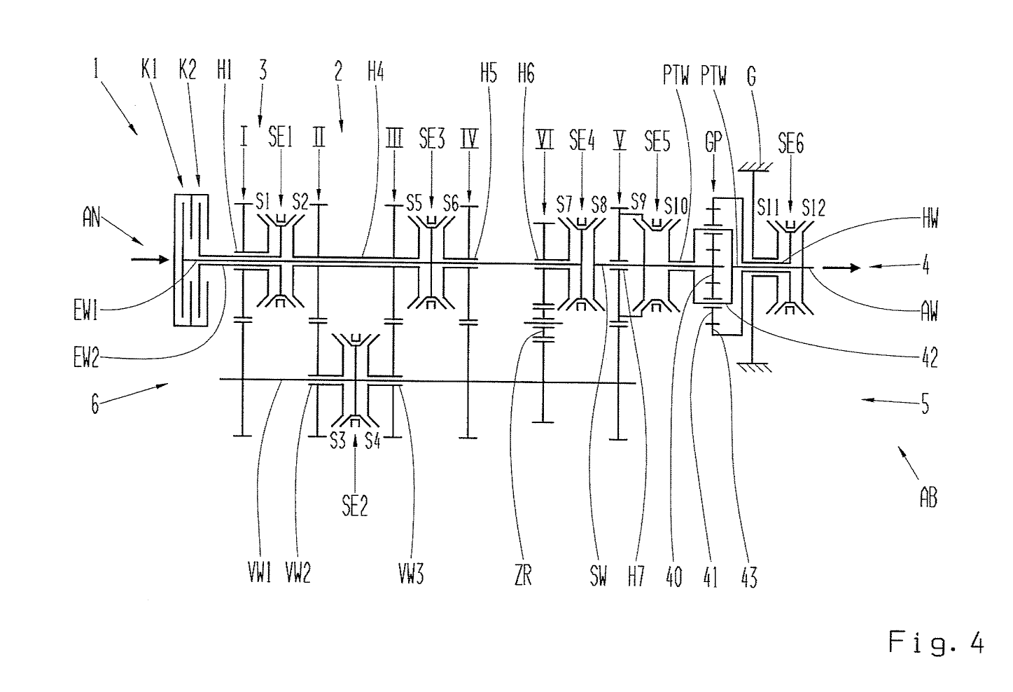

FIG. 4 shows a transmission in accordance with the third embodiment of the present invention.

FIG. 4 shows mainly a transmission 1 in accordance with FIG. 1. Different from the transmission 1 in accordance with FIG. 1, the transmission 1 in accordance with FIG. 4 has the second shift element SE2 now, instead on the input shaft axis 4, on the counter shaft axis 5 positioned. The third shift element S3 is now on one hand, connected with the first counter shaft VW1 and on the other hand with the second counter shaft VW2. The second counter shaft VW2 is designed as a hollow shaft and is positioned parallel and coaxial to the first counter shaft VW1 at its radial outer side. On the second counter shaft VW2, is positioned the transmission element which works together with the transmission element on the fourth hollow shaft H4 for the creation of the second gear plane II. The fourth shift element S4 is now connected on one hand with the first counter shaft VW1, on the other hand with the third counter shaft VW3. The third counter shaft VW3 is, like the second counter shaft VW2, designed as a hollow shaft and is positioned parallel and coaxial to the first counter shaft VW1 on its radial outer side. On the third counter shaft VW3 is a transmission element positioned which works together with the transmission element on the fourth hollow shaft H4 for the creation of the third gear plane III. The third shift element S3 and the fourth shift element S4 are further together positioned in the second shift device SE2 and can be actuated by means of the second shift element actuation device SB2.

The sequence of gear planes and shift elements on the counter shaft axis 5 is now, beginning from the drive side AN, as follows: first gear plane I, second gear plane II, third shift element S3, fourth shift element S4, third gear plane III, fourth gear plane IV, sixth gear plane VI, as well as the fifth gear plane V. The sequence of gear planes and shift elements on the input shaft axis 4 corresponds to the one in FIG. 1, without both of the shift elements S3 and S4.

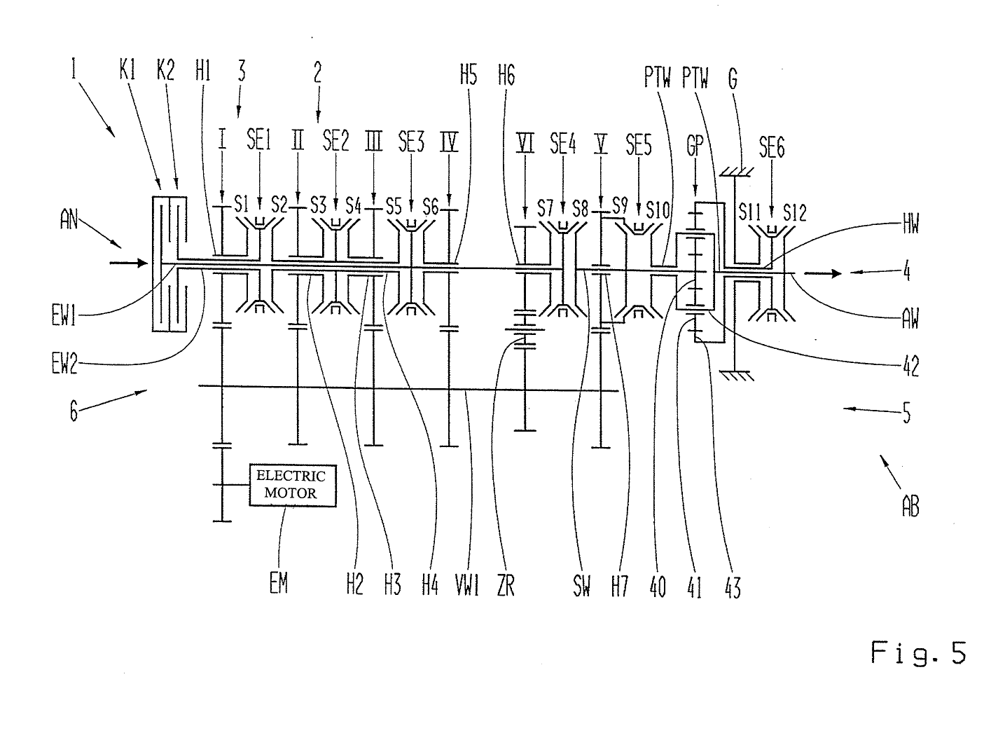

FIG. 5 shows a transmission in accordance with a fourth embodiment of the present invention.

FIG. 5 shows mainly a transmission 1 in accordance with FIG. 1. Different compared to the transmission 1 in accordance with FIG. 1 is that in the transmission 1, in accordance with FIG. 5, an electric machine EM is positioned to hybridize the transmission 1. The electric machine EM is connected via a shaft, and a transmission element on this shaft, with the transmission element on the first gear plane I on the counter shaft axis 5. Hereby, the electric machine EM can transfer the force and torques to the transmission element of the first gear plane I on the counter shaft axis 5 in further the via the gear planes on the input shafts EW1, EW2 and/or the sun shaft, in particular by means of at least a shift element, and provide therefore a hybridization of the transmission 1 through the output shaft AW. To include or couple, respectively, of the electric machine EM with the transmission can also be done through the transmission elements of the additional gear planes II, III, IV, V, and VI on the counter shaft axis 5, meaning the particular transmission elements on the counter shaft axis 5 which are fixed connected with a counter shaft VW1, VW2, VW3, which are designed and is solid shaft or as hollow shaft.

Altogether, the shift elements S1 to S12 in the transmission 1, in accordance with FIGS. 1 to 5, can also be called coupling devices and are in particular designed as synchronizations. The shift devices SE1 to SE6 or the shift element actuation devices SB1 to SB6 can be designed as double synchronizations in the case of two shift elements, and in case of just one shift element single synchronization. The transmission elements can be designed in particular in the transmission 1, in accordance with FIGS. 1 to 5, with the function of a fixed gear, as well as a function of an idle gear. For instance, in transmission 1, in accordance with FIG. 1, the transmission elements of the gear planes I-VI on the counter shaft axis 5 are designed for the first counter shaft axis VW1 as fixed wheels, because these are fixed connected with the counter shaft VW1 which is designed as solid shaft. The transmission elements of the first gear plane I and the second gear plane II on the input shaft axis 4 are positioned as idle gears for the second input shaft EW2, because these can be coupled by means of the first shift element S1 or rather the second shift element S2 with the second input shaft EW2.

The transmission elements can hereby be designed in particular in the form of gear wheels, preferably spur wheels, so that the gear planes I, II, III, IV, V, VI represents spur wheel steps. To provide different forward and reverse gears, meaning different gear ratios, the spur wheel steps and in particular their gear wheels can comprise of different gear ratios. Regarding the transmission 1 in accordance with FIGS. 1 to 5, the first shift element S1 can be assigned to the first gear plane I, the second shift element S2 to the two input shafts EW1, EW and the fourth hollow shaft H4, the third shift element S3 to the second gear plane II, a fourth shift element S4 to the third gear plane III, shift element S5 to the two input shafts EW1, EW2 and the fourth hollow shaft H4, the sixth shift element S6 to the fourth gear plane IV, the seventh shift element S7 to the sixth gear plane VI, the eighth shift element S8 to the two input shafts EW1, EW2 and the sun shaft SW, the ninth shift element S9 to the fifth gear plane V and the sun shaft SW, the tenth shift element S10 to the fifth gear plane V and the planetary (wheel) carrier shaft PTW, the eleventh shift element S11 to the enclosure G and the hollow shaft HW, as well as the twelfth shift element S12 to the ring gear shaft HW and the planetary (wheel) carrier shaft PTW.

In summary, the present invention offers also the advantage that a possible load shift group change between the slow group G1, related to the forward gears V1 to V5, and a fast group G2, comprising the forward gears V6 to V9 and the reverse gears R2 and R3 is made possible. Another advantage is the fact that the majority of shift devices are all positioned on the input shaft axis which functions as central axis and therefore, a comfortable possibility of the division of force, through the application of at least one counter shaft, are made possible. Another advantage is the fact that, through a total of six gear planes and a planetary transmission, at least nine forward gears and at least three reverse gears can be provided. Another advantage is the fact that a ninth forward gear enables the direct drive-through in the form of a direct gear and therefore, relative to the small step increases between the gears, in particular a relatively short first gear ratio is made possible. Finally, additional advantages are that the transmission has a good load shift ability and a good hybridization capability.

Although the present invention has been described above based on embodiment examples, it is not limited to these embodiments, but can be modified in many different ways.

The transmission 1, in accordance with FIGS. 1 to 5, can functionally be modified through different positioning of the gear planes and/or the shift elements. Hereby, the shift elements, in particular designed as synchronizations as mentioned before, can be assigned to the gear planes or shafts, respectively. The shift matrix in accordance with FIG. 2 does not change hereby through the new positioning of the gear planes and/or the shift elements and/or the shift devices.

### REFERENCE CHARACTERS

1 Transmission
2 First Partial Transmission
3 Second Partial Transmission
4 Input Shaft Axis
5 Countershaft Axis
6 Primary Reduction Gearing
40 Sun Gear
41 Planetary Gear
42 Bar
43 Ring Gear
I, II, III, IV, V, VI Gear plane
EW1, EW2 Input Shaft
SW Sun Gear Shaft
PTW Planet Carrier Shaft
HW Ring Gear Shaft
AW Output Shaft
H1, H2, H3, H4, H5, H6, H7 Hollow Shaft
K1, K2 First, Second Load Shift Element
S1, S2, S3, S4, S5, S6, S7, S8, S9, S10, S11, S12 Shift Element
SB1, SB2, SB3, SB4, SB5, SB6, Shift Element Actuation Device
SE1, SE2, SE3, SE4, SE5, SE6 Shift Device
VW1, VW2, VW3 Counter Shaft
ZR Intermediate Wheel
AN Drive Side
AB Output Side
EM Electric Machine
G Enclosure
V1, V2, V3, V4, V5, V6, V7, V8, V9 Forward Gear
R1, R2, R3 Reverse Gear

1-21. (canceled)

22. A transmission for a motor vehicle comprising:
at least first and second partial transmissions (2, 3),
each of the at least first and second partial transmissions (2, 3) having at least an input shaft (EW1, EW2) on a drive side (AN) of the transmission (1) which is positioned on an input shaft axis (4), an exit shaft as output shaft (AW) of the at least first and second partial transmissions (2, 3) on an output side (AB) of the transmission (1),
the output shaft (AW) being positioned either on the input shaft axis (4) or positioned parallel to the input shaft axis (4), a counter shaft axis (5) and a primary reduction gearing (6),
the primary reduction gearing (6) comprising at least a counter shaft,
at least one counter shaft (VW1, VW2, VW3) being positioned on the counter shaft axis (5),
a planetary transmission (GP) being connectable with the output shaft (AW),
at least one of the input shafts (EW1, EW2) being connectable with the output shaft (AW) via at least one of a number of wheel plane (I, II, III, IV, V, VI), at least one of a number of shift elements (S1, S2, S3, S4, S5, S6, S7, S8, S9, S10, S11, S12) and the planetary transmission (GP),
the number (M) of the wheel planes (I, II, III, IV, V, VI) and the number (N) of shift devices (SE1, SE2, SE3, SE4, SE5, SE6) both being natural numbers greater than or equal to two,
at least the number of shift devices minus one (N−1) shift devices (SE1, SE2, SE3, SE4, SE5, SE6) being positioned on the input shaft axis (4),
at least one shift element (S2) of one of the number of shift devices minus one (N−1) shift devices (SE1) being connected, via a shaft (H4), with at least a shift element (S5) of an additional (SE3) one of the shift devices (SE1, SE3, SE4, SE5, SE6), and, in each case, a transmission element with two wheel planes (II, III) being connected or connectable with the shaft (H4).

23. The transmission according to claim 22, wherein all of the shift elements (S1, S2, S3, S4, S5, S6) of the transmission (1) are positioned on the input shaft axis (4).

24. The transmission according to claim 22, wherein at least two shafts (EW1, EW2; VW1, VW2, VW3; EW2, EW1, SW, PTW, AW; H1, H2, H3, H4, H5, H6, H7) of the transmission (1) are positioned coaxially with respect to one another.

25. The transmission according to claim 22, wherein the number of wheel planes (M) and the number of shift devices (N) both equal six.

26. The transmission according to claim 22, wherein at least one of the input shaft, the counter shaft, the sun gear shaft, and the output shaft (EW1; VW1, SW, AW) of the transmission (1) is a solid shaft, and another of the input shaft, the counter shaft, the sun gear shaft, and the output shaft (EW2; VW2, VW3; H1, H2, H3, H4, H5, H6, H7, PTW), on a same axis (4, 5) of the transmission (1), is a hollow shaft.

27. The transmission according to claim 22, wherein at least one of the input shafts (EW1, EW2) of the transmission (1) is connected with a shaft (SW) of the planetary transmission (GP), which is designed as a sun shaft (SW).

28. The transmission according to claim 22, wherein at least one wheel plane (VI) is designed as a reverse gear step.

29. The transmission according to claim 28, wherein the reverse gear step (VI) is actuated by at least one (SE4) of the number (N) of shift devices (SE1, SE2, SE3, SE4, SE5, SE6), whereby one of the input shafts (EW1, EW1) is connectable with the reverse gear step by at least a shift element (SE4).

30. The transmission according to claim 28, wherein the shift device (SE4) for actuation of the reverse gear step (VI) is positioned further downstream of torque in an area of the at least one input shaft (EW1, EW2) on the input shaft axis (4).

31. The transmission according to claim 28, wherein at least one of the input shafts (EW1, EW2) is connectable with a shaft (SW), which is designed as sun shaft (SW) of the planetary transmission (GP), by one shift element (SE4) of the shift device (SE4) for the actuation of the reverse gear step (VI).

32. The transmission according to claim 22, further comprising the transmission (1) has at least three reverse gears (R1, R2, R3).

33. The transmission according to claim 22, wherein an electric machine (EM) is positioned at least at a transmission element of a wheel plane (I, II, III, IV, V, VI), at a counter shaft (VW1, VW2, VW3) and at one of the shafts (EW1, EW2, SW) on the input shaft axis (4) for the hybridization of the transmission (1), by at least one of an additional shift device and a transmission element which is connected therewith.

34. The transmission according to claim 33, wherein the electric machine (EM) is positioned at a transmission element of at least one (I, II, III, VI, V, VI) of the wheel planes (I, II, III, IV, V, VI) which is connected with a counter shaft (VW1), designed as a solid shaft.

35. The transmission according to claim 22, wherein a shift device (SE6) is positioned for actuation of the planetary transmission (GP), which comprises at least a shift element (S11), a ring gear (43) of the planetary transmission (GP), by at least a shift element (S11) is connectable in a rotationally fixed manner with an enclosure (G) of the transmission (1).

36. The transmission according to claim 35, wherein the shift device (SE6) comprises, for the actuation of the planetary transmission (GP), two shift elements (S11, S12), and the ring gear (43) is connectable by one of the two shift elements (S12) with a planetary carrier (42) of the planetary transmission (GP).

37. The transmission according to claim 22, wherein a planetary carrier shaft (PTW), of the planetary transmission (GP), is designed as the output shaft (AW).

38. The transmission according to claim 22, wherein a shift element (S10) of one of the number (N) of the shift devices (SE1, SE2, SE3, SE4, SE5, SE6,) is designed such that a transmission element on the input shaft axis (4) of one (V) of the number (M) of the wheel planes (I, II, III, IV, V, VI) is connectable with the planetary carrier (42) of the planetary transmission (GP).

39. The transmission according to claim 22, wherein the number (N) of the shift devices (SE1, SE2, SE3, SE4, SE5, SE6) and the number (M) of the wheel planes (I, II, III, IV, V, VI) and the planetary transmission (GP) are positioned such that the transmission (1) has at least nine forward gears (V1, V2, V3, V4, V5, V6, V7, V8, V9) and at least three reverse gears (R1, R2, R3).

40. The transmission according to claim 28, wherein the reverse gear step (VI) is positioned adjacent to a wheel plane (V) which is connectable with a sun shaft (SW).

41. The transmission according to claim 22, wherein the primary reduction gearing (6) comprises just a counter shaft (VW1) designed as a solid shaft.

42. A motor vehicle with a transmission (1) which comprises of at least first and second partial transmissions (2, 3), each of the at least first and second partial transmissions (2, 3) has at least an input shaft (EW1, EW2) on a drive side (AN) of the transmission (1) which is positioned on an input shaft axis (4),
an exit shaft as output shaft (AW) of the at least first and second partial transmissions (2, 3) on an output side (AB) of the transmission (1),
the output shaft (AW) being positioned on either the input shaft axis (4) or parallel to the input shaft axis (4), a counter shaft axis (5), and a primary reduction gearing (6),
the primary reduction gearing (6) comprising at least a counter shaft,
at least one counter shaft (VW1, VW2, VW3) being positioned on at least one of the counter shaft axis (5),
a planetary transmission (GP) being connectable with the output shaft (AW),
each of the input shafts (EW1, EW2) being connectable with the output shaft (AW) via the planetary transmission (GP) and at least one of a number of wheel planes (I, II, III, IV, V, VI) and at least one of a number of shift elements (S1, S2, S3, S4, S5, S6, S7, S8, S9, S10, S11, S12),
the number (M) of wheel planes (I, II, III, IV, V, VI) and the number (N) of shift devices (SE1, SE2, SE3, SE4, SE5, SE6) both being natural numbers at least equal to two, and
at least the number of shift devices minus one (N−1) shift devices (SE1, SE2, SE3, SE4, SE5, SE6) are positioned on the input shaft axis (4), at least one shift element (S2) of one of the number of shift devices minus one (N−1) shift devices (SE1) is connected via a shaft (H4) with at least a shift element (S5) of an additional (SE3) one of the shift devices (SE1, SE3, SE4, SE5, SE6) and in each case a transmission element of two wheel planes (II, III) is connected or connectable with the shaft (H4).
